(19) United States
(12) Patent Application Publication
(10) Pub. No.: US 2022/0354065 A1
(43) Pub. Date: Nov. 10, 2022

(54) Modular Planting System

(71) Applicant: Marly Garden LLC, New York, NY (US)

(72) Inventors: Alexander H. O'Brien, New York, NY (US); Cameron Hughes, New York, NY (US); Jamie D. Boling, Scottsdale, AZ (US)

(21) Appl. No.: 17/738,109

(22) Filed: May 6, 2022

Related U.S. Application Data
(60) Provisional application No. 63/278,829, filed on Nov. 12, 2021.
(60) Provisional application No. 63/192,899, filed on May 25, 2021.
(60) Provisional application No. 63/185,783, filed on May 7, 2021.

(51) Int. Cl. A01G 9/02; A01G 25/00; A01G 7/04

(52) U.S. Cl. CPC A01G 9/023; A01G 25/00; A01G 7/045

(57) ABSTRACT

Plant growing systems and apparatuses are described herein. The system may include a plurality of planter module apparatuses where each planter module has an outer module and an insert. The insert may be removeable. Each planter module may further include top and bottom ports to engage planter module legs and/or horticultural accessories. Each planter module may further include a reservoir and a moisture wick. Each planter module may include a watering ring. Each planter module may be electrified. Each planter module may further communicate with one or more computing devices.

### CROSS REFERENCE TO RELATED APPLICATIONS

The present application claims the benefit of: U.S. Provisional Application No. 63/278,829, filed on Nov. 12, 2021; U.S. Provisional Application No. 63/192,899, filed on May 25, 2021; and U.S. Provisional Application No. 63/185,783, filed on May 7, 2021. The above-identified applications are all incorporated herein by reference.

### FIELD

Aspects of this disclosure relate generally to horticulture and planting. More specifically, one or more aspects of the disclosure relate to modular, adaptable growing systems.

### BACKGROUND

Gardening is a hobby that many humans enjoy and have enjoyed for centuries. Gardening has improved lives by providing beauty, distraction, entertainment and a sense of accomplishment to people of all ages. Gardening also provides fresh and healthy herbs, fruits and vegetables to the grower. The grower can harvest the herbs and other produce as it matures and often at a time when the grower wants to immediately use the produce or use the produce shortly after harvest at a time when the flavors and health benefits are their strongest.

While it is beneficial to eat healthy, natural ingredients, living quarters and available space for gardening and plant growth is shrinking. Additionally, time is becoming less available for gardening and other hobbies. Further, people often can be intimidated to begin gardening, as it is perceived to be a complex and difficult hobby or project to be successfully started.

In addition to being a food source, indoor plants provide mental health support for many people by reducing stress. They also have been shown to help people recover from illness faster and increase their productivity. Indoor plants can help purify air and can also significantly reduce airborne volatile organic compounds (VOCs).

Gardening allows gardeners to increase healthy eating habits and reduce food costs and grow food in an organic and clean manner.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards systems and apparatuses for modular and adaptable planting.

One or more aspects of the present disclosure may include a modular planting system. The modular planting system may include a plurality of planter modules. Each planter module may include and out module. Each outer module may include an outer base, one or more closed outer walls extending upward from the outer base, and one or more closed interior walls of the outer module, interior to the one or more closed outer walls that extend upward from the outer base, and along with the outer base, define an outer module receiving cavity. Each outer module may further include a plurality of top ports disposed on a top side of the outer module between the one or more closed outer walls and the one or more closed interior walls of the outer module. Each outer module may further include a plurality of bottom ports disposed on the bottom side of the outer module between the one or more closed outer walls and the one or more closed interior walls of the outer module. Each planter module may further include an insert disposed within the outer module receiving cavity. The insert may include an insert base, and one or more closed insert walls extending upward from the insert base, and with the insert base defining a planting media volume.

The modular planter system as described herein may further include a system where the plurality of top ports of each planter module and the plurality of bottom ports of each planter module are configured to engage at least one of: a planter module leg; or a horticultural accessory.

The modular planter system as described herein may further include a system where the insert of each of the plurality of planter modules is removeable from the outer module receiving cavity of each of the plurality of planter modules.

The modular planter system as described herein may further include a system where at least one of the plurality of top ports of a portion of the plurality of planter modules is electrified and configured to deliver electrical power to at least one of: a horticultural accessory engaged with the top port; a portion of the plurality of planter modules; or a planter module leg engaged with the top port.

The modular planter system as described herein may further include a system where the insert base of a portion of the planter modules comprises a plurality of apertures therethrough.

The modular planter system as described herein may further include a system where the one or more closed outer walls of a portion of the planter modules are defined by a polygonal cross section comprising a plurality of sides and vertices. Further, the plurality of top ports of each planter module may be disposed adjacent to the plurality of vertices.

The modular planter system as described herein may further include a system where at least a portion of the planter modules further include a reservoir, where a portion of the outer base includes a concavity forming the reservoir between the outer module base and the insert base. At least a portion of the planter modules may further include a wick disposed in the planting media volume and may extend downward through the insert base and into the reservoir.

The modular planter system as described herein may further include a system where at least a portion of the planter modules further include a top surface between the one or more closed outer walls and the one or more closed interior walls of the outer module, and where the top surface is directed downward towards the outer module base.

The modular planter system as described herein may further include one or more planter module legs. Each planter module leg may be configured to engage with one of the bottom ports of the planter module.

The modular planter system as described herein may further include a system where the planter module leg may be adjustable.

The modular planter system as described herein may further include a system where each planter module leg may further be configured to engage with one or more another planter module leg.

The modular planter system as described herein may further include one or more horticultural accessories. The one or more horticultural accessories may be configured to acquire data associated with a plant within at least one planter module, and further configured to transmit the data to a computing device.

One or more further aspects of the present disclosure may relate to a planter module. The planter module may include an outer base, one or more closed out walls extending upward from the outer base. The planter module may further include one or more closed interior walls of the outer module, interior to the one or more closed outer walls, and extending upward from the outer base, and with the outer base, defining an outer module receiving cavity. The outer module may further include a plurality of top ports disposed on a top side of the outer module between the one or more closed outer walls and the one or more closed interior walls of the outer module. The planter module may further include an insert disposed within the outer module receiving cavity. The insert may include an insert base and one or more closed insert walls extending upward from the insert based, and with the insert base, defining a planting media volume.

The planter module as described herein may further include a planter module where the plurality of top ports and the plurality of bottom ports are configured to engage at least one of: a planter module leg; or a horticultural accessory.

The planter module as described herein may further include a planter module where the insert may be removeable from the outer module receiving cavity.

The planter module as described herein may further include a planter module where at least a plurality of top ports may be electrified and may be configured to deliver electrical power to at least one of: a horticultural accessory engaged with the top port; the planter module; or a planter module leg engaged with the top port.

The planter module as described herein may further include a planter module where the insert base comprises a plurality of apertures therethrough.

The planter module as described herein may further include a planter module where the one or more closed outer walls are defined by a polygonal cross section comprising a plurality of sides and vertices, and wherein the plurality of top ports may be adjacent to the plurality of vertices.

The planter module as described herein may further include a reservoir, where a portion of the outer bae may include a concavity forming the reservoir between the outer module based and the insert base. The planter module may further include a wick disposed in the planting media volume which may extend downward through the insert base and into the reservoir.

The planter module as described herein may further include a top surface between the one or more closed outer walls and the one or more closed interior walls of the outer module, where the top surface may be directed downward toward the outer module base.

These and other aspects, objects, and features of the present invention will be understood and appreciated by those skilled in the art upon studying the following specification, claims, and appended drawings.

### BRIEF DESCRIPTION OF THE DRAWINGS

Some of the features of the present disclosure are illustrated by way of example, and not limitation, in the accompanying drawings in which like reference numerals indicate similar elements and in which:

FIG. 1 is a perspective view of an illustrative configuration of a modular growing system for plants according to one or more illustrative embodiments as described herein.

FIG. 2 is a top view of a modular planting system for plants according to one or more illustrative embodiments as described herein.

FIG. 3 is a perspective view of an alternative illustrative configuration of a modular planting system for plants according to one or more illustrative embodiments as described herein.

FIG. 4 is a perspective view of four individual planter modules according to one or more illustrative embodiments as described herein.

FIG. 5 is a perspective view of an illustrative configuration of a modular planting system for plants placed on a countertop or table according to one or more illustrative embodiments as described herein.

FIG. 6 is a perspective view of a two-tier planter module according to one or more illustrative embodiments as described herein.

FIG. 7 is a perspective view of a single planter module including legs, a solar powered grow light, and a planting media monitor attachment according to one or more illustrative embodiments as described herein.

FIG. 8 is a perspective view of two single planter modules of the modular planting system adjoined with one another according to one or more illustrative embodiments as described herein.

FIG. 9 is a section view of a single planter module including a solar powered grow light and a planting media monitor attachment, where the section is taken along lines 8-8 in FIG. 7, according to one or more illustrative embodiments as described herein.

FIG. 10 is a side view of a single planter module with a water level indicator window according to one or more illustrative embodiments as described herein.

FIG. 11 is a top perspective view of a planter module of the present disclosure including the interior of a top insert portion where planting media and plant roots will be positioned and having draining apertures in the base thereof according to one or more illustrative embodiments as described herein.

FIG. 12 is a perspective view of a single planter module including an insert and watering ring according to one or more illustrative embodiments as described herein.

FIG. 13 is an exploded view of a single planter module including a plant, grow media, and an insert according to one or more illustrative embodiments as described herein.

FIG. 14 is a perspective view of a person who has removed the insert portion and is watering or leaching the planting media of extra, unabsorbed minerals according to one or more illustrative embodiments as described herein.

FIG. 15 is a perspective view of a configuration of a modular system according to an aspect of the present disclosure with a user holding their mobile device to monitor the modular planting system according to one or more illustrative embodiments as described herein.

FIG. 16 is a perspective view of a mobile computing device touch sensitive display (or screen) showing a modular planting system for plants as part of a mobile application for controlling and/or monitoring the modular system according to one or more illustrative embodiments as described herein.

FIG. 17 is a perspective view of a modular planting system positioned and used as an outdoor raised bed garden according to one or more illustrative embodiments as described herein.

### DETAILED DESCRIPTION

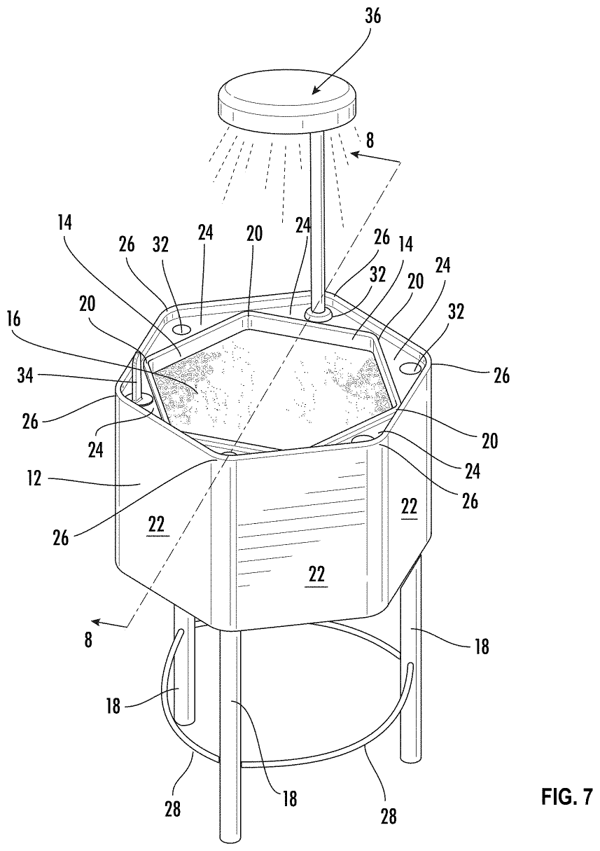

For purposes of description herein, the terms “upper,” “lower,” “right,” “left,” “rear,” “front,” “vertical,” “horizontal,” and derivatives thereof shall relate to the invention as oriented in FIG. 7 However, it is to be understood that the description herein and the claimed invention may assume various alternative orientations, except where expressly specified to the contrary. It is also to be understood that the specific devices and processes illustrated in the attached drawings, and described in the following specification are simply example embodiments of the inventive concepts defined in the appended claims. Hence, specific dimensions and other physical characteristics relating to the embodiments disclosed herein are not to be considered as limiting, but rather other embodiments may be utilized, and structural and functional modifications may be made without departing from the scope of the present disclosure.

Where a range of values is provided, it is understood that each intervening value, to the tenth of the unit of the lower limit unless the context clearly dictates otherwise, between the upper and lower limit of that range, and any other stated or intervening value in that stated range, is encompassed within the scope of the present disclosure. The upper and lower limits of these smaller ranges may independently be included in the smaller ranges, and are also encompassed within the scope of the present disclosure, subject to any specifically excluded limit in the stated range. Where the stated range includes one or both of the limits, ranges excluding either or both of those included limits are also included in the scope of the present disclosure.

Generally speaking, the modular planting systems 10 of the present disclosure provide for a gardening system that is compact and makes gardening simpler for any person. In certain aspects the modular planting systems 10 of the present disclosure are intelligent planting systems that may incorporate a mobile application, web application or native application that provides the systems of the present disclosure the data tracking capability, the proactive recommendations to the user and/or the automated handling of one or a plurality of the planting conditions for each planter within the overall modular planting systems 10 of the present disclosure.

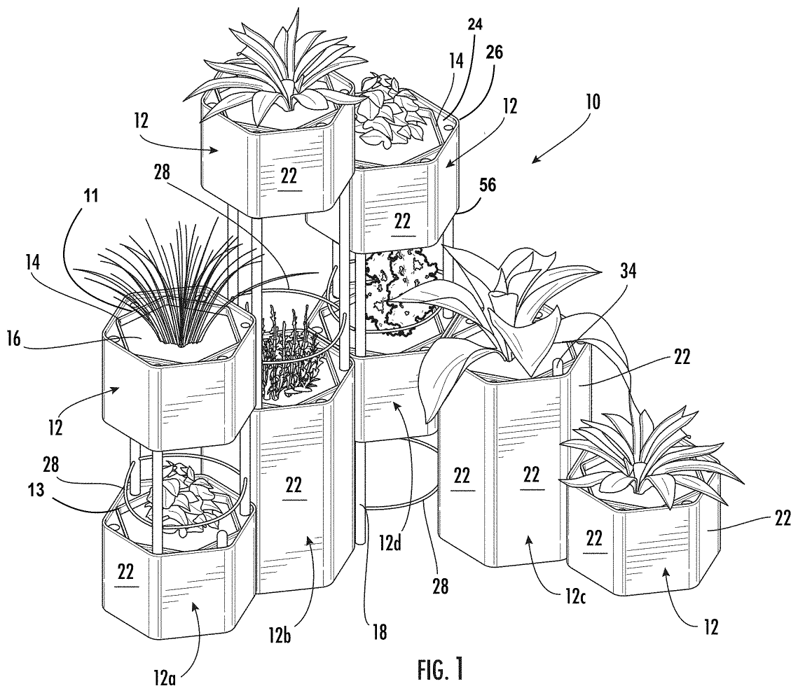

FIG. 1 is a perspective view of an illustrative configuration of a modular planting system 10 for plants including variously sized abutted and tiered planter modules 12 according to one or more illustrative embodiments. Referring to FIG. 1, the modular planting system 10 of the present disclosure may incorporate a plurality of individual planter modules 12. Many examples of planter modules 12a, 12b, 12c, etc. are provided herein and are generally referred to as planter modules 12. Each of the individual planter modules 12 in a modular planting system 10 may be the same size and have the same cross-sectional shape and dimensions. Alternatively, the individual planter modules 12 may be of different sizes and the same cross-sectional shape, or some of the individual planter modules 12 may be different from one another in size and/or cross-sectional shape, or all of the planter modules 12 may conceivably have different sizes and cross-sectional shapes.

Still referring to FIG. 1, the cross-sectional shapes of some, or all of the planter modules 12 of a modular system 10 may be shaped to allow a combination of the planter modules to be tessellated with one another without overlapping or substantial gaps between the planter modules, thereby providing efficient use of space when desired by the user of the modular planting system 10 of the present disclosure. As non-limiting examples, tessellating planter modules 12 may have hexagonal, square or triangular cross-sectional shapes. Additionally, multiple different cross-sectional shapes that tesselate when put together may be used in the same modular planting system. This efficient use of space is not necessary, but may be advantageous in small living spaces or where it is generally desired to conserve space. This configuration and tessellation feature may also allow for efficient use of space on patios and on rooftop gardens in urban or suburban settings and other similar environments. As will be discussed below, the planter modules 12 of the present disclosure may also be positioned vertically above one or more other planter modules 12.

According to aspects herein some, or all, of the individual planter modules 12 in a modular planting system may be of differently sized and shaped polygonal cross-sectional area. Accordingly, the individual planter modules 12 of the modular planting system 10 may abut one another in a mosaic or non-uniform pattern. Adjacent planters may or may not fully tessellate. For example, one side of each of two pentagonal planter modules 12 may abut two different sides of a third pentagonal planter module 12. Alternatively, one side of each of two hexagonal planter modules 12 may abut two different sides of a triangular planter module 12. In such illustrative aspects, the planter modules 12 of the modular planting system 10 may fit together in a mosaic pattern while not necessarily tessellating the plane, unless with a differently shaped additional planter module 12. Adjacent planter modules 12 may abut each other at their sides 22. Gaps may or may not be present between adjacent planter modules 12. Alternatively, adjacent planter modules may abut each other at their vertices 26. Further, a vertex 26 of one planter module 12 may abut a side 22 of an adjacent planter module 12. All polygonal and otherwise shaped and sized planter modules 12 and all arrangements of such polygonal planter modules 12 are herein contemplated.

While the cross-sectional shape of the planter modules 12 of the present disclosure may be a variety of polygonal shapes that may be tessellated and/or may abut one another, modular planting systems 10 of the present disclosure may be disconnected somewhat from one another as well and may include shapes that do not substantially abut (e.g., circle). Regardless of the cross-sectional shape of the planter module 12 selected for the modular planting system 10, the modular planting system 10 so selected may permit the user to selectively align the various planter modules 12 with each other and optionally maximize space usage when so desired, which may also create an aesthetically appealing system. In addition to being optionally configured in a tessellated and/or mosaic manner, the systems of the present disclosure may also create added space vertically where desired as shown in the figures (e.g., FIGS. 1, 3, and 6). This may provide even more planting surface area than the footprint surface area of a modular planting system 10 of the present disclosure. Additionally, single planter modules 12 of any shape and size may be used in isolation.

As shown in at least FIGS. 1-8 and still referring to FIG. 1, the polygonal shaped planter module 12, may be a smaller height, tiered planter module 12a, an independent larger planter module 12c, or a larger height tiered planter module 12b positioned below a second planter. Alternatively, a larger height tiered planter module 12b may be positioned above a smaller height tiered planter module 12a. Additionally, a planter module 12d may be installed on legs 18 or supports or on a level of a multi-level shelving structure and elevated at a user selectable height above the surface where the modular system is placed. Essentially the planter modules 12 of the modular planting system 10 may be of any height and have any top surface area. To adjust the top surface area, the perimeter dimensions may be changed. Planter modules 12 may have a hexagonal cross section with a height of from about 8 inches to about 30 inches tall. They may be about 12 inches tall for a shorter version of the planter module 12a and about 24 inches tall for the taller version of the planter module 12b, 12c. However, planter modules 12 of any polygonal shape, size and height are contemplated herein, and the present disclosure is not intended to limit the possible size of a planer module 12 in any way. Each side of a hexagonally shaped planter module 12 may range from about 2 inches for smaller plants like herbs and succulents to about 3, 4 or 5 feet for larger modules. In some aspects, the sides are each from about 6 inches to about 12 inches. However, planter modules 12 of any shape and size are contemplated herein.

Still referring to FIG. 1, planter modules 12 may include a polygonal exterior, including closed outer walls 15 and an outer base 56, defining the overall size and shape of the planter module 12. The outer walls 15 may include outer sides 22 and outer vertices 26. Planter modules 12 may also include an interior planting media 16 containing volume that may be established by an insert 80 (described in further detail below) having insert wall 14 defined by at least one side 11. According to aspects, the insert wall 14 may be defined by a polygonal cross-section with insert sides 11 and vertices 13 in a number equaling that of the outer walls 15. In other embodiments, the insert wall 14 may be defined by a circular-cross-section or any other shaped cross-section. The media planting volume may be any capacity. In some illustrative aspects, the media planting volume may range from about 0.5 cubic feet to about 2 cubic feet for indoor plant modules 12 and from about 1 cubic foot to about 3 cubic feet for outdoor planter modules 12. However, media planting volumes of any capacity are contemplated herein. According to aspects herein, planter modules 12 may be formed of at least two distinct parts, an outer planter module 12 and an insert 80. According to other aspects, the outer module and the insert 80 may be a single unified part. According to aspects including a separate outer planter module 12 and insert 80, the outer planter module 12 may include all outer features of a planter module 12 (e.g., outer walls 15, top ports 32, bottom ports 30, interior walls 1302 etc.) that are described herein.

In illustrative examples of planter module 12, the insert walls 14 may form a hexagonal shape defined by a hexagonal cross-section. The outer wall may also from a hexagonal shape defined by a hexagonal cross-section. In such illustrative aspects, the insert wall 14 may be oriented such that its vertices 20 are positioned near or exactly at the midpoint of each of the outer sides 22. This may establish difference regions 24 of space between the outer vertices 26 and the insert wall 14. The difference regions 24 may have alternating functional ports and/or universal top ports 32. According to other embodiments, the outer closed wall may have any shaped cross-section (e.g., circular triangular, pentagonal, square, octagonal etc.) and the insert wall 14 may have any shaped cross-section (e.g., circular, plus sign shaped, polygonal etc.). In such embodiments, difference regions 24 may be defined by one or more spaces between the closed outer wall 15 and the insert wall 14.

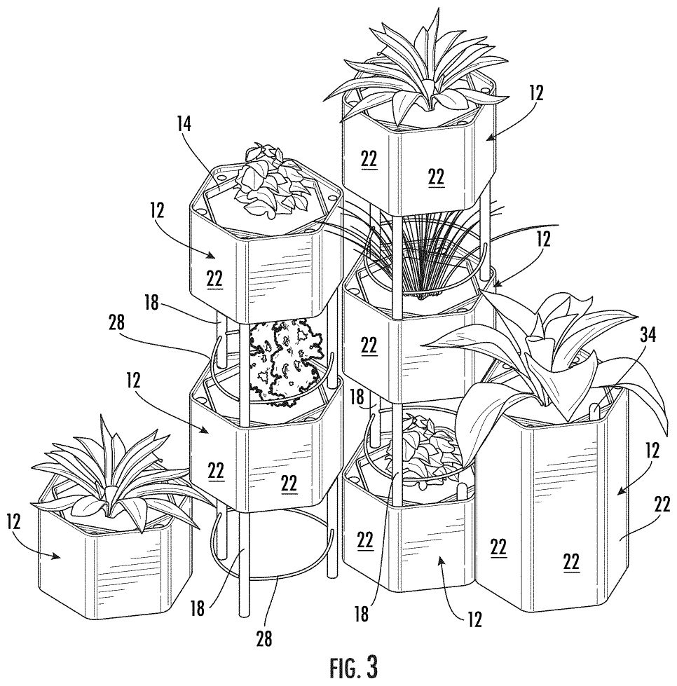

FIG. 3 is a perspective view of an alternative illustrative configuration of a modular planting system 10 for plants including a three-tier planter according to one or more illustrative embodiments. Referring to FIG. 3, the top ports 32 may be configured to receive a planter module leg 18 of any height to hold another planter module 12 above a lower planter module 12. The upper planter module 12 may receive a planter module leg 18, on an opposite end of the planter module leg 18, elevating the second planter module 12 above the first. Each of the planter modules 12 may have corresponding planter module leg 18 engagement bottom ports 30 in the bottom side difference region 81 of the planter modules 12 to engage the legs 18. The legs 18 may be engaged in the bottom ports 30 to hold an upper planter module over a lower planter module. Alternatively, the legs 18 may be engaged in the bottom ports 30 to raise a single planter module off a support surface (e.g., floor, counter top 48, etc.). The legs 18 may be frictionally engaged or otherwise engaged by hand and without the use of tools with the top ports 32 and bottom ports 30 of the planter modules 12. Alternatively, the planter module legs 18 may snap into the top ports 32 or bottom ports 32. In another alternative, the planter module legs 18 may be screwed into the top ports 32 or bottom ports 30. The planter module legs 18 may be made of any material including but not limited to sheet metal, a metal covered with wood, plastic, or wood. The planter module legs may also require tools for engagement and/or disengagement from the top ports 32 and/or bottom ports 30.

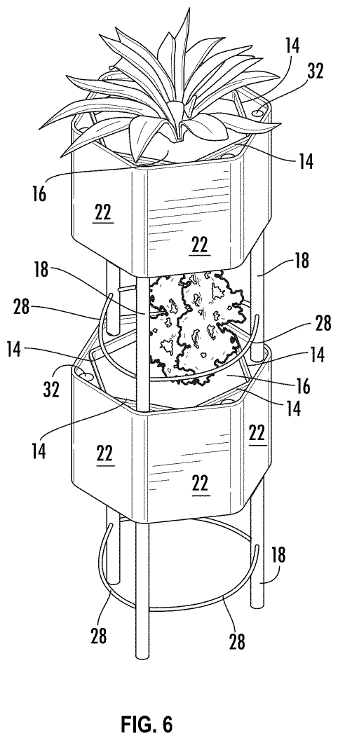

Still referring to FIG. 3, the planter module legs 18 may be additionally supported by arcuate or linear horizontal planter module leg supports 28. The planter module leg supports 28 may span between and attach to two neighboring planter module legs 18 thereby supporting and strengthening the overall modular planting system 10. The arcuate or linear horizontal supports 28 between the planter module legs 18 may further function to support the plant located in the planter module 12 positioned below it. In this configuration, the supports 28 may help to hold up growing foliage and facilitate growth. They may also keep the foliage from falling into contact with the planting media 16 within the planter module on the bottom of the configuration shown in FIG. 6.

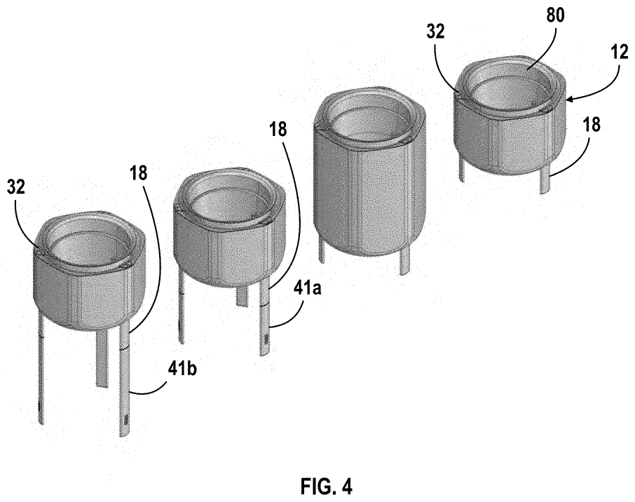

FIG. 4 is a perspective view of four individual planter modules 12 according to one or more illustrative embodiments as described herein. Planter module legs 18 may engage with planter module 12 planter module leg extensions 41. Multiple examples of planter module leg extensions 41 (e.g., 41a and 41b) are provided herein and are generally referred to as planter module leg extensions 41. Leg extensions 41 may be added to planter module legs 18 allowing variability of planter module 12 height. Leg extensions 41 may be used to raise a single planter module 12 off a support surface. Additionally, leg extensions 41 may be used to vary the distance between an upper planter module 12 and a lower planter module 12 when engaged as described herein. Leg extensions 41 may be variously sized as illustrated by short planter module leg extension 41a and long planter module leg extension 41b. Further, planter module legs 18, and planter module leg extensions 41 may be adjustable in height allowing the user to select the height of the planter module legs 18 and planter module leg extensions 41 and in turn the planter module 12 to which they may be attached. Multiple planter module leg extensions 41 may be used together and stacked one on top of the other. Comparable to planter module legs 18, planter module leg extensions 41 may similarly engage with and connect to top ports 32 and bottom ports 30 as described in relation to planter module legs 18 herein. As described below regarding planter module legs 18, planter module leg extensions 41 may similarly function to provide electrical power, a network connection, and/or a data connection from one planter module 12 to another. Planter module leg extensions 41 and planter module legs 18 may be identical in form and function and may be operably interchangeable.

Finger holes may be provided on one or more of the planter modules 12. The finger holes may be circular or otherwise shaped and may facilitate lifting of the planter module 12 for moving the planter module 12 from one location to another.

Referring to FIG. 1, each of the planter modules 12 may be configured to have at least one plant grow in planting media 16. As discussed above, each planter module 12 may be equipped with six top ports 32. Three top ports 32 may be slightly smaller in diameter than the others and adapted to accept planter module legs 18 of another upper planter module 12 to be positioned above the lower planter module 12. The other three top ports 32 may be designed to engage and optionally provide power, and/or a network connection to, any one of a plurality of different horticultural accessories. The differently sized top ports 32 may alternate with one another to provide the functional ports on a variety of sides of the plant(s) within the plant module 12. Alternatively, all of the top ports 32 may be universal ports functioning to accept the planter module legs 18 of another planter module 12 or functioning to engage and, for example, provide power, a network connection, and/or a data connection to any one of a plurality of different horticultural accessories as described in more detail below. Any number of top ports 32 is contemplated herein. Additionally, a top port 32 of a lower planter module 12 engaged with a planter module leg 18 may provide electrical power, a network connection, and/or a data connection to the planter module leg 18 which may in turn provide power, a network connection, and/or a data connection to the upper planter module 12 through the planter module leg 18 and bottom port 30.

Horticultural accessories (e.g., grow light 36, or planting media 16 moisture monitor 34) may be used with the plant modules 12 and modular planting system 10 to provide added functionality and connectivity and may be configured to provide user selectable add-on features. Alternatively, the horticultural accessories may be completely omitted from the systems of the present disclosure. Top ports 32 that are not used for a horticultural accessory or planter module legs 18 may be covered with a moisture tight sealing plug to keep water and debris out of it and prevent harm to any electrical connections therein, when present. One horticultural accessory may be, for example, a planting media 16 moisture sensor 34 that may include an analog or digital moisture sensor 34 operably connected with the planter module. A planting media 16 moisture sensor 34 or other horticultural accessory may derive power from a battery or batteries, which may be rechargeable batteries recharged from solar power or directly. Alternatively, a planting media moisture sensor or other horticultural accessory may be powered by an electrical connection provided to the planter module 12 or the overall modular planting system 10 where electrical power is provided from an electrical power source to one or more planter modules 12 and then shared from one module to another via electrical connection(s) between planter modules 12. For example, electrical connections, network connections, and/or data connections through the planter module legs 18 interconnecting modules may be provided where the planter module legs 18 may have electrical connections running through the inner of the planter module leg(s) 18 so as not to be visible to the user(s) of the modular planting system 10 of the present disclosure. Additionally, two abutting adjacent planter modules 12 may share an electrical connection through, for example, a plug and socket on sides 22 of the outer walls of the adjacent planter modules 12. According to an embodiment, each of multiple abutting adjacent modules may have an electrical socket on their sides 22. A double plug adapter may be disposed between the abutting adjacent planter modules 12 thereby completing an electrical connection. Other methods of electrically connecting, network connecting and data connecting planter modules 12 in a modular planting system 10 are herein contemplated.

Additionally, a plurality of planting media sensors may be employed such that, in addition to moisture content, other features of the planting media such as pH and/or other factors may be measured and provided to the user via communication with a mobile computing device or other computing device. Other accessories that may be employed include cameras to see and measure leaf color, for example. The camera may also be utilized to securely share a live or periodic video stream of some or all of the plants in various pots of a user's planting system according the present disclosure. In this manner the user may selectively share the growth progress of one or more of the plants in the user's systems with a single person or multiple people connected via the website or mobile application. In this manner, the other users may also send SMS, MMS, RCS, IM, etc. alerts or other alerts to other user's notifying them that their plants may need attention. For example, other users may notify a person that their plants require water, or more or less light. Other users may also be able to notify a person of plant disease that the person may not yet see or appreciate where other more experienced users may notice.

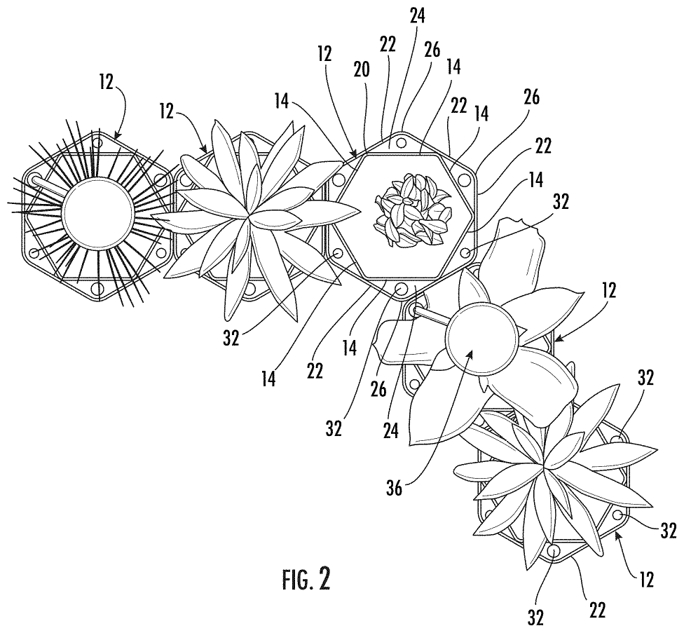

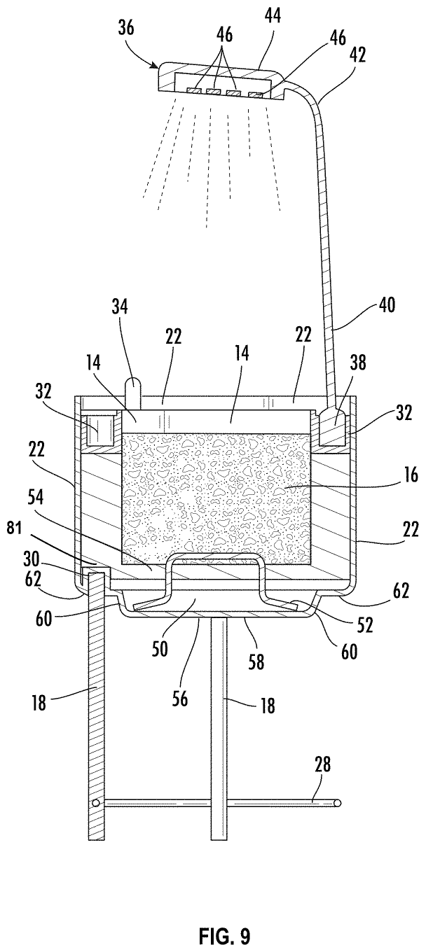

As shown in FIGS. 2 and 7-8, the systems may employ a grow light 36 or other illumination providing accessory. FIG. 9 is a section view of a single planter module 12 including a solar powered grow light 36 and a planting media monitor attachment, where the section is taken along lines 8-8 in FIG. 7, according to one or more illustrative embodiments. Referring to FIG. 9, the grow light 36 may contain one or more LED light 46 arrays that may be configured to provide a light spectrum uniquely configured to the particular plant being grown underneath it. The light spectrum of the grow light 36 may be configured using a mobile application, web application or other application associated with the modular planting system 10. The spectrum may be automatically set to provide the light spectrum based on the plant being grown in the planter module 12 by the user. Alternatively, the spectrum may be automatically selected when the user enters the type of plant being grown in that particular module 12 by, for example, scanning a UPC, barcode, or other visual code (e.g., a QR code) on a seed packet or seedling container using, for example, a camera of the mobile computing device. The application may then access a database that correlates the QR Code, UPC, or other visual perceptible code with a given plant. In other embodiments, a visual picture of an actual growing plant may be captured and the particular plant species or type may be discerned by photographing the plant itself. Integration of a plant identification application such as PLANTNET™, iNATURALIST®, PLANTSNAP®, or PICTURETHIS® may be done to allow a user to use the camera of the mobile computing device, or otherwise uploaded photo, to identify the plant being placed in a particular module. After a plant or seed in a particular planter module 12 is identified, planting media moisture parameters, lighting conditions including the type and amount of light to be provided, recommended planting media type, recommended fertilizers, recommended fertilization schedule, and other parameters may be automatically updated for the plant profile.

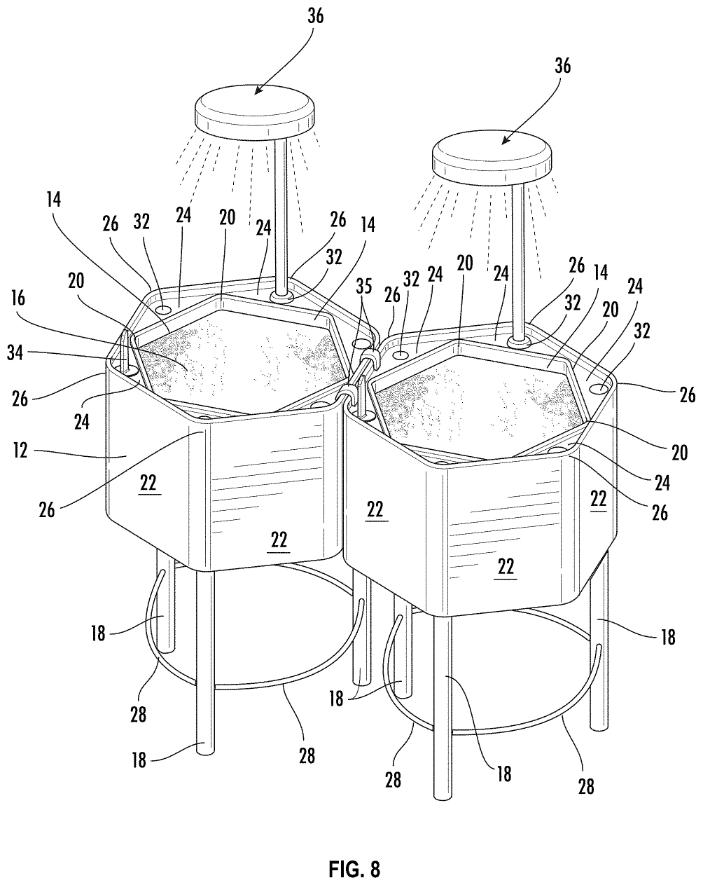

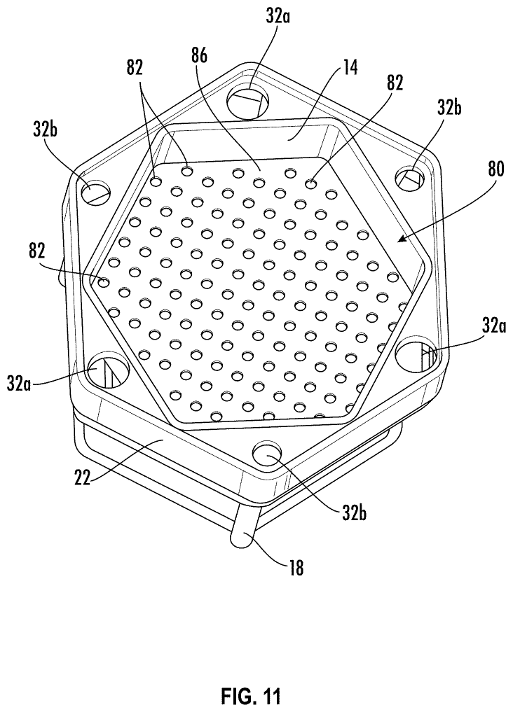

Still referring to FIG. 9, the grow light 36 or illumination providing accessory, as shown in FIGS. 7-8, may include at least a base portion 38 that may be seated in and engaged with the top port 32. The top port 32 may or may not provide power to the grow light 36 or illumination providing accessory. The top ports 32 employed on a single planter module 12 may be the same diameter or same interior shapes or volume or have different diameters or interior shapes or volumes (as shown in FIG. 11) where large top port 32a has a larger cross-sectional diameter at the top than small top port 32b. For the grow light 36 or illumination providing accessory positioned on a topmost module 12, the grow light 36 or illumination providing accessory may have an upwardly extending stem portion 40 that may extend upward to a height that is higher than the height of the plant within the planter module 12. At the top of the stem portion 40, distal from the base portion 38, the stem may have an arcuate neck portion 42 that may be fixed or bendable and transitions to an overhanging portion 44 that may be positioned over a center portion of the module 12. The overhanging portion 44 may be a puck-like shape with a circular horizontal cross-section as shown in the figures, but could conceivably be any shape. On the underside portion may be positioned an array of LED 46 or other lights that may provide a broad spectrum of light that may be adjusted by the user or the system automatically based on the plant being grown in the planter module 12. According to embodiments, other kinds of lights, for example, incandescent, fluorescent, high-intensity discharge, etc. illumination providing accessories or grow lights 36 may be employed instead of or in addition to the LED 46 array. Any accessory could conceivably be engaged with any of the ports.

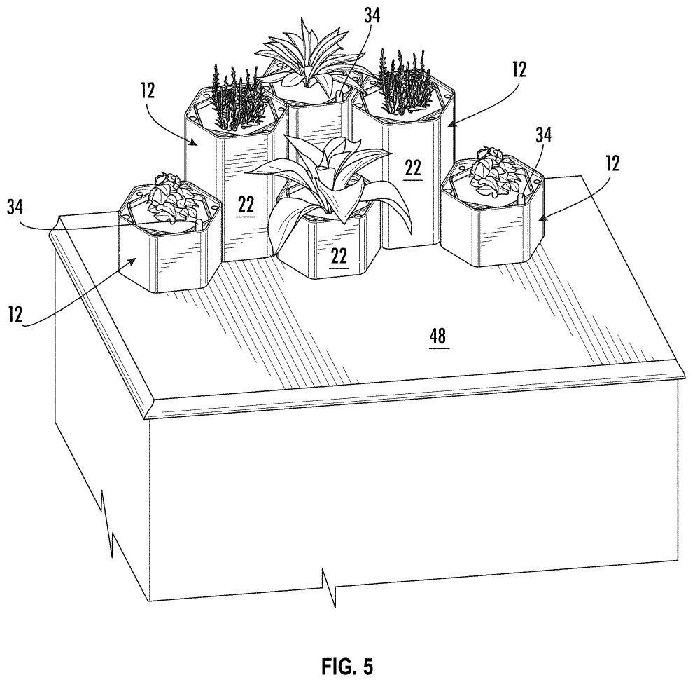

As discussed above, the modular planting system 10 of the present disclosure may be configured in a variety of orientations by a user of the system. Referring to FIG. 3, the modular planting system 10 may include a three-tier planter system, a two-tier planter system, a single large planter and a single small planter. Any number of planters may be tiered on one another and is contemplated herein. Referring to FIG. 5, the modular planting system may be adapted to use on any support surface such as a standard countertop 48. FIG. 6 shows an illustrative single two-tiered modular planting system. FIG. 8 shows two adjoining planter modules 12 that are positioned next to one another and affixed to one another to provide greater stabilization using one or a plurality of generally U-shaped brackets 35 to engage two abutting sides with one another. The brackets 35 may be friction fit brackets that snap or snugly fit over the sides of abutting planter modules 12 thereby affixing the configurations together. The brackets can also be affixed to the two modules using one or two fasteners such as a screw or nut and bolt traveling from one side of the bracket to the other or at least into contact with each side of the module from each side of the bracket 35. Abutting planter modules 12 may be joined by any number of brackets. Two adjacent abutting modules may be affixed using clips, brackets, screws, adhesives, complementary tracks, or any reasonable method of adjoining two such bodies known to those of ordinary skill in the art.

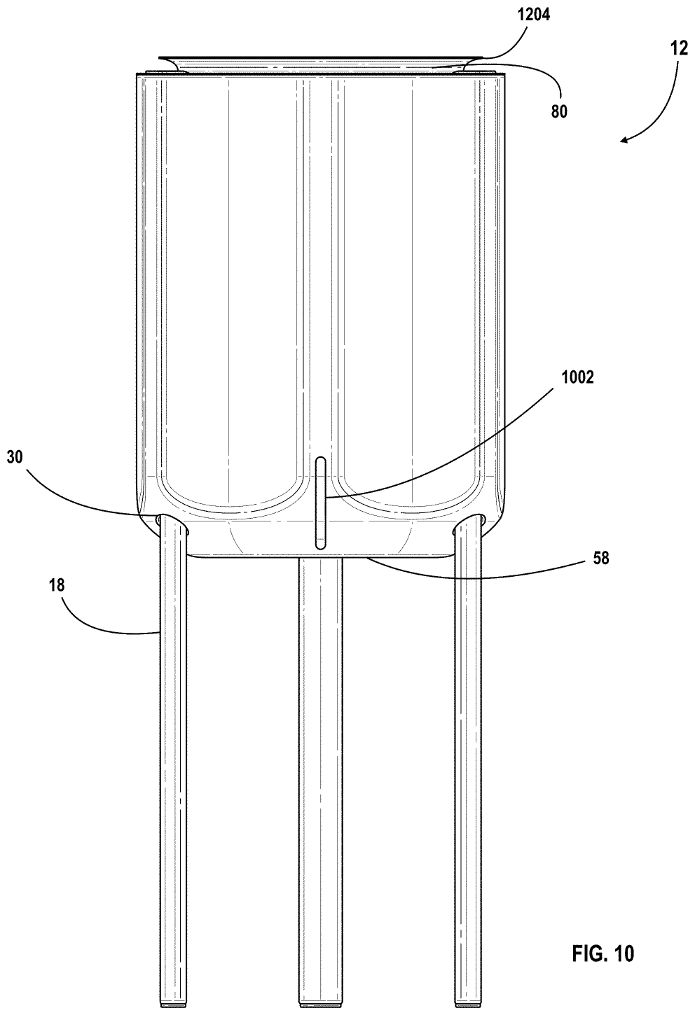

FIG. 11 is a top perspective view of a planter module 12 of the present disclosure including the interior of a top insert 80 portion where planting media and plant roots may be positioned and having draining apertures 82 in the base thereof according to one or more illustrative embodiments. As shown in FIGS. 10-14 and referring to FIG. 11, one, a plurality, or all of the planter modules 12 of a given system according to an aspect of the present disclosure may incorporate a removable insert 80. The insert 80 may be defined by a hexagonal cross-section, circular cross-section or any other shaped cross-section. The insert 80 may be removable from the outer planter module 12 volume by hand and without the use of tools and may be frictionally fit and/or held in place by gravity within the overall planter module 12. The insert 80 may be removed from its seated position in the planter module 12 and water supplied to the plant 84 from a water supply positioned otherwise out of reach of the planter module 12 or modules.

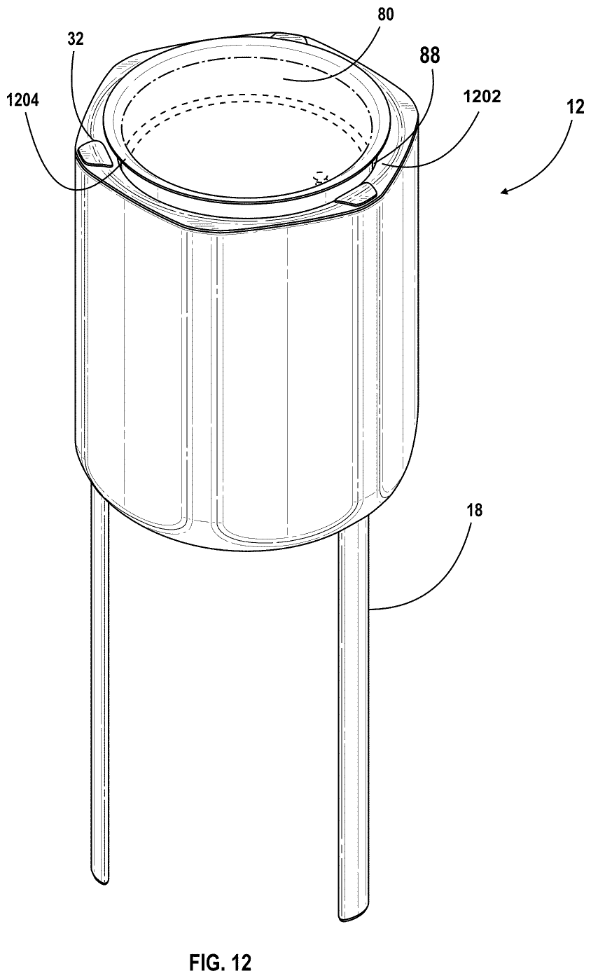

FIG. 12 is a perspective view of a single planter module 12 including an insert 80 and watering ring 1202 according to one or more illustrative embodiments. Referring to FIG. 12, the insert 80 may include an outwardly extending lip 1204 that may project outward from the top of the sides of the insert 80 and extend around all or substantially all or a portion of the upper perimeter of the insert to facilitate grasping of the insert and lifting for watering and/or leaching as described herein. The lip 1204 may have a substantially L-shaped cross-section or an arcuate cross-section, but could conceivably be at any angle extending away from the upper perimeter. Alternatively, the lip may extend inwardly. In an alternative illustrative aspect, at least two opposite sides of the insert 80 may include a finger receiving indentation (not shown) that creates a lip or ledge that may facilitate the removal of the insert 80 from its seated/installed position within the planter module 12. The finger receiving indentations may be present on the exterior or interior surface of the opposing side of the insert 80 and may be sized to fit any number of fingers. According to other illustrative aspects, instead of finger receiving indentations, loops (not shown) on or proximate the top surface of the sides of the insert 80 may be used. Another feature that could be employed in addition to or instead of the above are one or more finger receiving holes (not shown) on the upper portion of the sides of the insert 80.

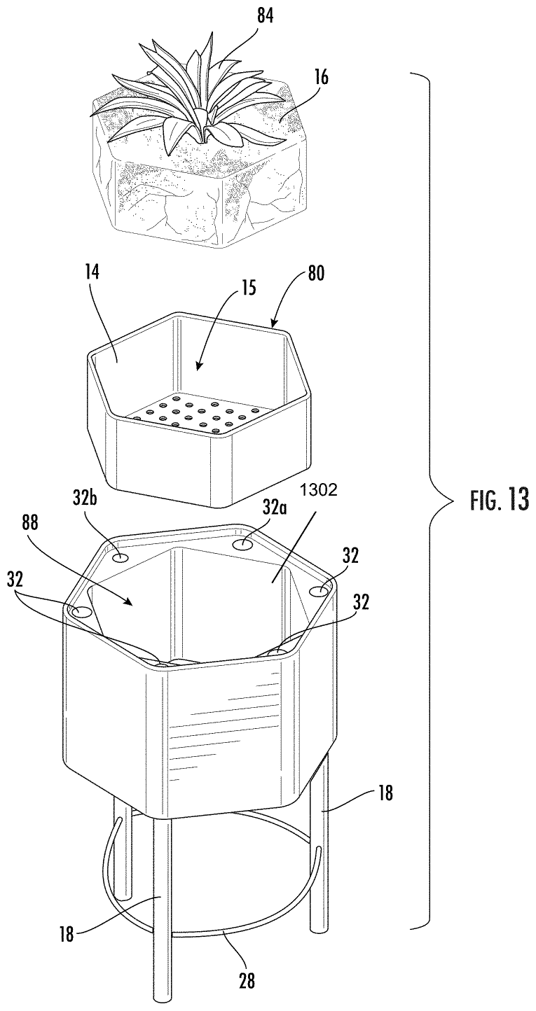

FIG. 13 is an exploded view of a single planter module 12 showing a plant 84, grow media 16, and an insert 80 according to one or more illustrative embodiments. Referring to FIG. 13, in use, the insert 80 may contain the roots and planting media 16 of the plant 84. The base 86 of the insert 80 may contain a plurality of apertures 82 thereon that may allow water to pass therethrough when the plant 84 within the insert 80 is watered. The apertures 82 may be round, but the apertures 82 could be any shape. The apertures 82 may be any size sufficient to allow water to pass through. The amount and size of the apertures may be such that water is allowed to pass through at a rate sufficient to leach the planting media of minerals when desired by a person while also retaining planting media and roots substantially within the insert 80. The insert 80, when removed, shows the receiving cavity 88 within the planter module 12 volume. The receiving cavity 88 may include one or more closed interior walls 1302. The interior walls 1302 may be disposed interior to the outer walls 15. The interior walls 1302 may extend upward from the outer base 86

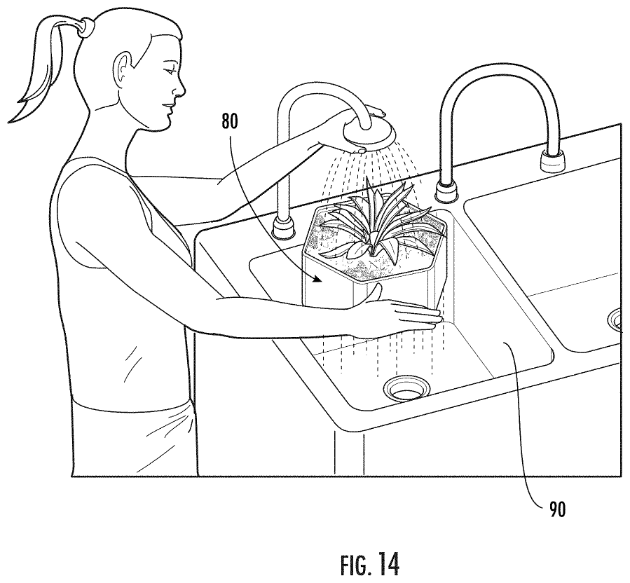

FIG. 14 is a perspective view of a person who has removed the insert 80 portion and is watering or leaching the planting media 16 of extra, unabsorbed minerals according to one or more illustrative embodiments. Referring to FIG. 14, a person may remove the insert 80 containing the planting media 16 and plant 84 by hand and without the use of tools using the insert walls 14 themselves. When present, the opposing side finger receiving indentations on the upper portion of the side walls of the insert 80 may be used to grasp the insert walls 14 of to remove it from the overall module. To water the plant 84 within the insert 80, water may be applied as shown in FIG. 14. Some plants may benefit from saturating the planting media 16 and roots and then allowing excess water to drain; the insert 80 may allow for such watering regiments. Additionally, the insert 80 may also enable the easy leaching of the planting media 16 to remove minerals. To leach minerals from the plant's 84 planting media 16 within the insert 80, the plant's 84 planting media 16 may be watered within a sink 90, bathtub or outdoors to moisten the root ball. Then a period of time sufficient for salts and/or minerals to dissolve may be allowed to pass, which may be more or less time depending on the amount of salts and/or minerals and the amount of planting media 16 being leached and the amount of salts and/or minerals desired to be leached. Additional water may be allowed to flow through the insert 80 and out the apertures 82 to remove the dissolved salts/minerals from the planting media. This leaching process may lower the concentration of salts within the planting media within the insert 80.

Referring to FIG. 9, planter modules 12 may have a wicking reservoir 50 and a wick 52. The wicking reservoir 50 may be formed as a concavity in the outer base 56 According to aspects herein, the wicking reservoir may be formed as the space between the outer base 56 and the insert base 86. The wick may be any of a variety of materials or combination of materials including but not limited to a ceramic or a cotton rope material. A wick 52 of any wicking material is herein contemplated. It will be appreciated by those of ordinary skill in the art that different applications may benefit from different wick 52 materials. The wick 52 may extend below the inner base 54 of the interior volume of the module 12. The wick 52 ends may be positioned within the reservoir 50 which is a space between the interior base 54 and the outer base 56 of the module 12. The outer base 56 may have a predominantly flat center portion 58 and angled sides 60 that extend and connect to the base lip perimeter portion 62, which meet integrally with the sides 22. The wick 52 may be shaped in a curved manner such that the first end contacts the wicking reservoir 50, then extends upwardly into the planting media 16, where the mid-point may contact the planting media 16 for approximately half of the total distance of the planter 12 and then extends downwardly such that the second end contacts the wicking reservoir 50. The wick 52 may be a “sponge-like” piece that draws water from the wicking reservoir 50. This is done through capillary action—the intermolecular attraction in liquids, along with the attractive forces between a liquid and a solid material with narrow tubes or small spaces within it. The human gardener may provide sufficient water when initially planting the seedlings, both in the pot and in the wicking reservoir. When the plants start to grow, they may use water to do so and they may release additional water from their leaves. More water may then be drawn, through capillary action, from the plant roots from the planting media to replace that which was used and lost. Water may then be absorbed into the planting media from the wick 52, where the roots may be able to replace water into the root system, as needed. This system may allow the planting media to remain consistently moist. The mobile application, web application or other application may be able to alert the human user when the wicking reservoir needs to be refilled using the moisture sensors and the application.

FIG. 10 is a side view of a single planter module 12 with a water level indicator window 1002 according to one or more illustrative embodiments of the present disclosure. As described herein, the wicking reservoir 50 may be filled with water and may provide, via the wick 52, moisture to the planting media 16 and plant. A determination of the water level, or lack thereof, in the wicking reservoir 50 may be desirable for the user of the present disclosure. Further, it may be advantageous for the user to make such a water level determination without having to remove any of the planter module 12 parts. Referring to FIG. 10, planter modules 12 may include one or more water level indicator windows 1002. The water level indicator window 1002 may comprise a piece of glass, plastic, plexiglass, etc. or any transparent material. The water level indicator window 1002 may allow the user to see, from the outside of the planter module 12, the water level within the wicking reservoir 50. The water level indicator window 1002 may contain graduations along its height and may provide, for example, volumetric information (e.g., 50 ml, 100 ml, 150 ml etc.), relative fill information (e.g., full, half full, empty etc.) or any other graduated information. Additionally or alternatively, the graduations may be disposed on the planter exterior proximate the water level indicator window 1002.

According to illustrative aspects of the present disclosure, the water level of the wicking reservoir 50 may be indicated variously. For example, a water level sensor and/or indicator may be engaged with a top port 32 sensing and indicating the water level in the wicking reservoir below. Additionally or alternatively, a water level sensor may be disposed within the wicking reservoir 50. Water levels may then be communicated to, for example, a screen or a computing device in a similar manner to that which is described in relation to growing accessories herein.

Referring to FIG. 12, planter modules 12 may include a watering ring top surface 1202. The watering ring top surface 1202 may be located on the top surface of the planter module 12 and may extend around a portion of, all of, or substantially all of the planter module 12. As illustrated in FIG. 12, the insert 80 may sit within the receiving cavity 88 in the planter module 12 volume. A gap may be present between the insert 80 and the receiving cavity 88 walls. The watering ring top surface 1202 may have a curved or angled surface, directed downward toward the wicking reservoir 50, such that when water is poured on the watering ring 1202, the water is directed toward the inner volume of the planter module 12 between the insert 80 and the receiving cavity 88 walls. When water is poured over the watering ring 1202, it may be directed into the planter module 12 inner volume and into the wicking reservoir 50 below. The watering ring 1202 may allow for the filling of the wicking reservoir 50 by pouring water anywhere on the watering ring 1202 without the removal of the insert 80.

Additionally or alternatively, the tops of the planter modules 12 may include filling ports (not shown). Such filling ports may lead from the top of the planter module 12 to the wicking reservoir 50 and may allow a user to fill the wicking reservoir 50 from the filling ports.

One or more bottom mounted grow lights or illumination providing accessories (not shown) may be engaged with the bottom surface of the planter module 12 on the predominantly flat center portion 58 or within a cavity or cavities on the downward facing surfaces of the module for use when the planter module 12 is positioned above another module when an upwardly extending grow light 36 or illumination providing accessory having a stem is not able to be used or not aesthetically acceptable to the user. Such a bottom mounted grow light or illumination providing accessory may be powered from the module it is engaged with or via batteries.

Modular planting systems 10 of the present disclosure may include blank modules (not shown). Such blank modules may be used in place of any of the above described planter modules 12. In such illustrative aspects, blank modules may allow for the continuation of a tessellated or mosaicked module pattern, and may allow for connection among planter modules 12 where a planter is not desired. Blank modules may also be used to facilitate electrical connection between planter modules 12. Blank modules may also contain computing devices and other electronics. Such computing devices and electronics may facilitate interconnectivity of entire modular planting systems 10. Further, the computing devices and electronics may facilitate connectivity to and integration with the mobile application, web application, or other applications described herein.

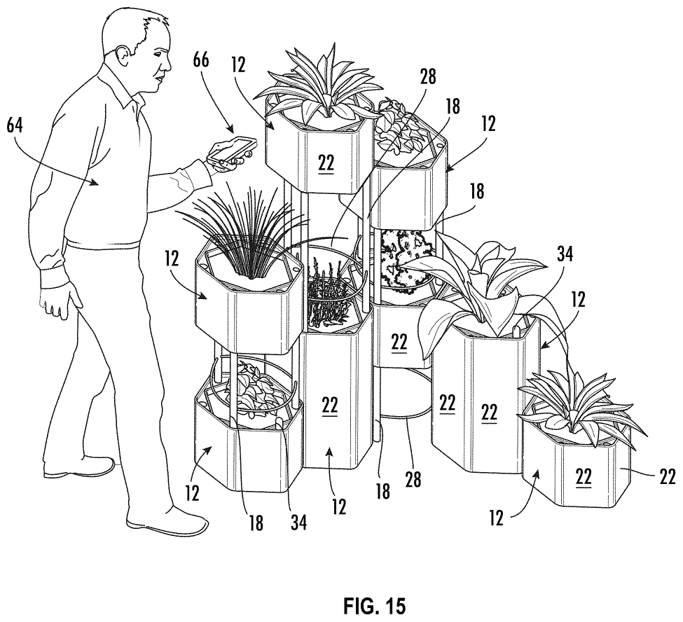

FIG. 15 is a perspective view of a configuration of a modular system 10 according to an aspect of the present disclosure with a user 64 holding their mobile device 66 to monitor the modular planting system 10 according to one or more illustrative embodiments. Referring to FIG. 15, a user 64 of a mobile computing device 66 may scan the plants in the modular planting system 10 using a camera of the mobile computing device 66 to configure the mobile application or mobile computing device enabled website or other website accessed using the mobile computing device to ascertain what type of plant is in each planter module 12 and/or regulate and monitor the health and status of the unique plants within each of the modules. The user 64 is shown viewing their mobile computing device 66.

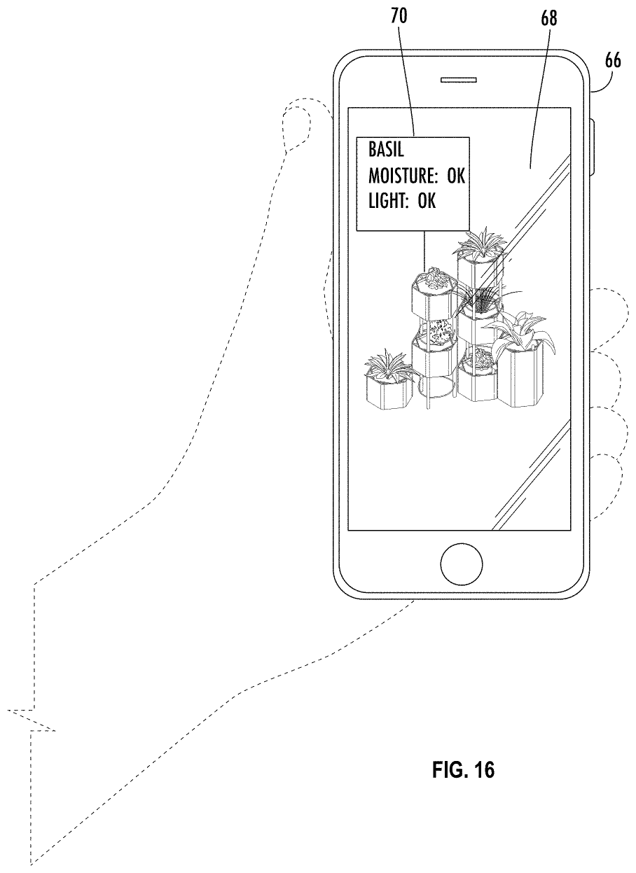

FIG. 16 is a perspective view of a mobile computing device 66 touch sensitive display 68 (or screen) showing a modular planting system 10 for plants as part of a mobile application for controlling and/or monitoring the modular system according to one or more illustrative embodiments. Referring to FIG. 16, the mobile computing device 66 may display information regarding the status of a user selected planter module 12 of a plurality of planter modules 12 of a given modular planting system 10 according to an aspect of the present disclosure. According to examples, the mobile computing device 66 may display an information callout box 70 which may overlay the image of the system configuration of the user or be a separately displayed page or user display screen. Some information that may be displayed includes the type of plant growing within the planter module 12, in this example case “basil”, and other information for example moisture levels, light levels, plant health, planting media PH, planting media composition, etc. Overall health may be displayed as well. Additionally, the mobile application may gather data and information from the sensor(s) of the modular planting systems 10 of the present disclosure. The mobile application may then communicate with the user regarding the sensor data and information and prompt the user to take some kind of action such as watering a plant within one or a plurality of particular planter modules 12 of the overall system or prompt the user to adjust light levels or the spectrum of light provided to each module. The mobile application may additionally or alternatively communicate with the modular planting system 10 and automatically prompt the modular planting system 10 to take an action. For example, the system may automatically water a plant, turn a grow light 36 on/off, alter the spectrum of a grow light 36, etc. It is to be understood, that any function possibly performed by a mobile device 66 may also be performed by alternate computing devices, for example a desktop or laptop computer. Additionally, any function performed by a mobile device application may be performed by various other applications, for example a web application, or a native application, etc.

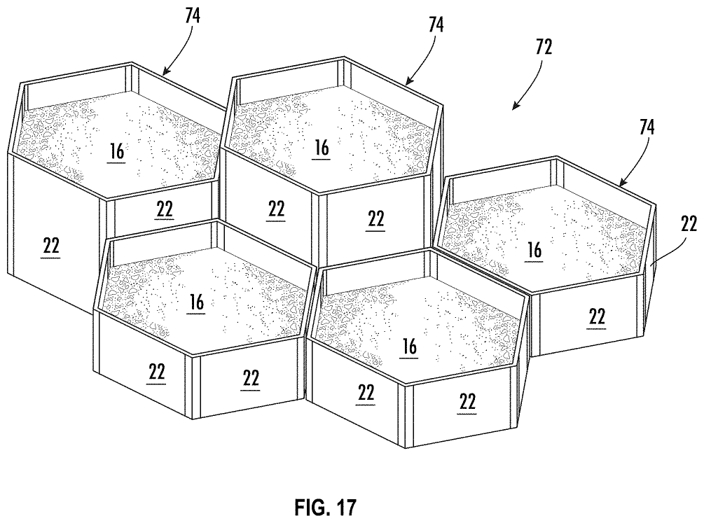

FIG. 17 is a perspective view of a modular planting system positioned and used as an outdoor raised bed garden 72 according to one or more illustrative embodiments. Referring to FIG. 17, raised bed garden planters 74, which may be hexagonal in shape can be aligned in such a manner to maximize outdoor gardening space. According to other embodiments, differently shaped polygonal raised bed garden planters 74 may be used alone or in combination. Such raised bed garden planters 74 may be substantially the same as the planter modules 12 of the present disclosure, but may not contain an insert wall or walls 14. Raised bed garden planters 74 may be entirely filled with planting media 16. While moisture sensors and other planting media status monitoring sensors may be used, they may be directly inserted into the planting media in the case of the raised bed gardens 72 of the present disclosure. Lighting systems may also conceivably be used. Outdoor raised bed gardens 72 may allow gardeners to enhance their gardening experience through gardening outdoors in peak gardening season. The mobile application and community as described herein may provide optimum planting and harvesting times for seedlings sent and curated by the manufacturer.

As described above, the present disclosure describes a modular planting system 10, which allows for stacking and adjoining planter modules 12 to maximize space. As discussed herein, the modular planting system 10 may include a mobile application. The mobile application may be able to take photos of the modular setup and inform the human gardener how their plants are doing, when they need to be watered and when they may need more or less sunlight or artificial growing illumination lights. The fully integrated systems according to an aspect of the present disclosure may be able to control and track watering and sunlight and overall plant well-being to assist the gardener in a successful harvest. The mobile application may also contain a “Community” element, where gardeners may be able to upload what herbs and vegetables they are growing and see what others in their area may be growing so they may be able to exchange their harvest and/or generally support one another. There may also be a “Local Events” aspect/section of this application. In this section of the mobile application, the application may provide a communication platform where like-minded gardeners can gather and grow in their knowledge of gardening. Additionally, “Recipes” may be included in the mobile application that may provide featured recipes that may allow the gardeners to utilize their own harvest and the harvest from community members to create meals.

The modular gardening systems of the present disclosure may further utilize a direct-to-consumer multi-channel sales platform, including showrooms with knowledgeable sales specialists, a high-touch delivery service, and helpful support teams. Owners of a modular gardening system according to the present disclosure may sign up for and pay a seasonal fee for consulting services and suggestions for seasonal plants. The seasonal plants may be plants the owner of the system has already indicated they enjoy or would like the fruit or vegetable yielded by the plant, or alternatively, plants the owner may desire to know more about or begin growing based on their previous growing habits. The systems, including the mobile application system, may proactively request confirmation of the plants or seeds to be delivered and/or make suggestions based on past purchases or feedback received from the owner and/or based on seeds or plants previously ordered.

Additionally, it is presently contemplated that other users of a different modular planting system 10 may teach one another using the website or mobile application as a hub to connect with one another from remote locations. Additionally, horticultural experts and/or gardening instructors may teach classes for owners of modular planting systems 10 of the present disclosure who may have paid a seasonal or monthly or a different periodic fee. The mobile application may include video conferencing features that may allow multiple users of the system to confer with one another. Further, the video conferencing features may allow instructors and experts to video confer with users of the system. The video conferencing features may be designed specifically for users of the systems of the present disclosure. Such conferencing features may allow those in a conference to show or access modular planting system 10 historical and current statistic and other modular planting system 10 information.

As described above, horticultural experts and teachers may teach classes for the owners of modular planting systems 10. These instructors may be world-class instructors that may teach classes across a variety of gardening and wellness disciplines, including canning, terrarium construction, succulent and plant care, cooking, skincare remedies, flowers, cannabis cultivation and meditation. These programs may create and allow access to a vast and constantly updated library of thousands of gardening and wellness programs for an owner and/or subscriber to utilize and learn from over time. Classes may be located by filtering the library of classes available based on class type, instructor, plant genre, length, available equipment, area of concentration, and/or combinations thereof. Additionally, via the internet accessible website or mobile application, new, seasonal varieties of plants each season may be shipped to the owner to complement the owner's evolving plant menus and inform the owner of the modular planting system 10 about new varieties of plants they may enjoy for pleasure or harvesting or both using the planters of the present disclosure.

Content may be available through a monthly connected gardening subscription, which may allow for unlimited gardening across multiple users within a household. A connected gardening subscriber may be able to enjoy classes anywhere through the mobile application associated with a plurality of modular planting systems 10 and users of modular planting systems 10, which may be accessible using a mobile computing device with a touch sensitive display screen, as well as most tablets and computers.

Upon ordering a modular planting system 10, the proper planting media and seedlings may also be delivered to the human gardener. Seedlings and planting media may then be sent to the gardener as needed for future planting needs. The systems of the present disclosure may provide the foundational groundwork to make the modern person a skilled gardener as well as the guidance, support, time efficiency and the ability to maximize the space used to grow the maximum yield. In addition to the modular planting system 10, a compost container, outdoor raised bed garden and wall plants may be available to the gardening community and may be configured in a similar manner to other aspects of the present disclosure and may be used alone or in conjunction with aspects of the present disclosure. A compost container according to the present disclosure may be available in several sizes and may be able to be adapted to fit each gardener's needs in regards to space, amount, and size. A compost container according to an aspect of the present disclosure may be utilized in any of a variety of sizes and may be stored on the kitchen counter or outside as needed by the user. The size may be adaptable to the modular planting system, which may allow planters to be stacked on top of it and a larger size that may be stored outside. The mobile application may allow the gardener to quickly access information regarding what may or may not be composted and track the health of the compost material based on data inputs by the user and/or sensors in or on the compost container.

Compost containers may be designed to speed the decomposition of organic matter and food waste through proper aeration and moisture retention. The organic matter and food waste may be turned into compost through high temperatures that are created by the activity of aerobic organisms, who may flourish in the environment created by the air and moisture. The compost container may be equipped with sensors that may be able to track the temperature, moisture level, and/or bacterial activity of the compost. The compost bin may be equipped with a turner, in illustrative aspects, an automated turner. In either case, the turner may be tracked in the application. The automated turning option may be done on a set schedule, with the press of a button on the application, or when the sensors inside the bin trigger turning. The non-automated turner may be turned manually, but each time the turning is done, the user may input the turning into the application, to ensure the application is able to adequately track the quality of the compost. Alternatively, the compost container may be turned manually and/or the application may be able to track and update the turning automatically.

Wall planters may allow for additional plants to be planted without taking additional space. The wall planters may utilize the same technology as the other planters described in this disclosure, but allow a gardener to save additional space.

It will be understood by one having ordinary skill in the art that construction of the described invention and other components is not limited to any specific material. Other illustrative embodiments of the invention disclosed herein may be formed from a wide variety of materials, unless described otherwise herein.

For purposes of this disclosure, the term “coupled” in all its forms, couple, coupling, coupled, etc. generally means the joining of two components electrical or mechanical directly or indirectly to one another. Such joining may be stationary in nature or movable in nature. Such joining may be achieved with the two components electrical or mechanical and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the illustrative embodiments is illustrative only. Although only a few embodiments of the present innovations have been described in detail in this disclosure, those skilled in the art who review this disclosure will readily appreciate that many modifications are possible e.g., variations in sizes, dimensions, structures, shapes and proportions of the various elements, values of parameters, mounting arrangements, use of materials, colors, orientations, etc. without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide enough strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other illustrative embodiments without departing from the spirit of the present innovations.

It will be understood that any described processes or steps within described processes may be combined with other disclosed processes or steps to form structures within the scope of the present invention. The illustrative structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A modular planter system comprising:
a plurality of planter modules, each planter module comprising:
an outer module comprising:
an outer base;
one or more closed outer walls extending upward from the outer base;
one or more closed interior walls of the outer module, interior to the one or more closed outer walls, and extending upward from the outer base, and with the outer base, defining an outer module receiving cavity;
a plurality of top ports disposed on a top side of the outer module between the one or more closed outer walls and the one or more closed interior walls of the outer module;
a plurality of bottom ports disposed on a bottom side of the outer module between the one or more closed outer walls and the one or more closed interior walls of the outer module;
an insert disposed within the outer module receiving cavity comprising:
an insert base; and
one or more closed insert walls extending upward from the insert base, and with the insert base, defining a planting media volume.

2. The modular planter system of claim 1, wherein the plurality of top ports and the plurality of bottom ports are configured to engage at least one of:
a planter module leg; or
a horticultural accessory.

3. The modular planter system of claim 1, wherein the insert of each of the plurality of planter modules is removeable from the outer module receiving cavity of each of the plurality of planter modules.

4. The modular planter system of claim 1, wherein at least one of the plurality of top ports of a portion of the plurality of planter modules is electrified and configured to deliver electrical power to at least one of:
a horticultural accessory engaged with the top port;
the plurality of planter modules; or
a planter module leg engaged with the top port.

5. The modular planter system of claim 1, wherein the insert base of a portion of the planter modules comprises a plurality of apertures therethrough.

6. The modular planter system of claim 1, wherein the one or more closed outer walls of a portion of the planter modules are defined by a polygonal cross section comprising a plurality of sides and vertices, and wherein the plurality of top ports are disposed adjacent to the plurality of vertices.

7. The modular planter system of claim 1, wherein at least a portion of the planter modules further comprise:
a reservoir,
wherein a portion of the outer base comprises a concavity forming the reservoir between the outer module base and the insert base; and
a wick disposed in the planting media volume and extending downward through the insert base and into the reservoir.

8. The modular planter system of claim 1, wherein at least a portion of the planter modules further comprise:
a top surface between the one or more closed outer walls and the one or more closed interior walls of the outer module,
wherein the top surface is directed downward towards the outer module base.

9. The modular planter system of claim 1, further comprising:
one or more planter module legs,
wherein each planter module leg is configured to engage with one of the bottom ports of a planter module.

10. The modular planter system of claim 9, wherein the planter module leg is adjustable in length.

11. The modular planter system of claim 9, wherein each planter module leg is further configured to engage with one or more another planter module legs.

12. The modular planter system of claim 1, further comprising:
one or more horticultural accessories,
wherein the one or more horticultural accessories are configured to acquire data associated with a plant within at least one planter module, and further configured to transmit the data to a computing device.

13. A planter module comprising:
an outer module comprising:
an outer base;
one or more closed outer walls extending upward from the outer base;
one or more closed interior outer walls of the outer module, interior to the one or more closed outer walls, and extending upward from the outer base, and with the outer base, defining an outer module receiving cavity;
a plurality of top ports disposed on a top side of the outer module between the one or more closed outer walls and the one or more closed interior walls of the outer module;
a plurality of bottom ports disposed on a bottom side of the outer module between the one or more closed outer walls and the one or more closed interior walls of the outer module;
an insert disposed within the outer module receiving cavity comprising:
an insert base; and
one or more closed insert walls extending upward from the insert base, and with the insert base, defining a planting media volume.

14. The planter module of claim 13, wherein the plurality of top ports and the plurality of bottom ports are configured to engage at least one of:
a planter module leg; or
a horticultural accessory.

15. The planter module of claim 13, wherein the insert is removeable from the outer module receiving cavity.

16. The planter module of claim 13, wherein at least one of the plurality of top ports is electrified and configured to deliver electrical power to at least one of:
a horticultural accessory engaged with the top port;
the planter module; or
a planter module leg engaged with the top port.

17. The planter module of claim 13, wherein the insert base comprises a plurality of apertures therethrough.

18. The planter module of claim 13, wherein the one or more closed outer walls are defined by a polygonal cross section comprising a plurality of sides and vertices, and wherein the plurality of top ports are disposed adjacent to the plurality of vertices.

19. The planter module of claim 13, further comprising:
a reservoir,
wherein a portion of the outer base comprises a concavity forming the reservoir between the outer module base and the insert base; and
a wick disposed in the planting media volume and extending downward through the insert base and into the reservoir.

20. The planter module of claim 13, further comprising:
a top surface between the one or more closed outer walls and the one or more closed interior walls of the outer module,
wherein the top surface is directed downward towards the outer module base.
